(19) United States
(12) Patent Application Publication
(10) Pub. No.: US 2025/0321471 A1
(43) Pub. Date: Oct. 16, 2025

(54) PROJECTION DEVICE AND CONTROL METHOD THEREOF

(71) Applicant: Coretronic Corporation, Hsin-Chu (TW)

(72) Inventors: Wen-Jui Huang, Hsin-Chu (TW); Wen-Hao Chu, Hsin-Chu (TW)

(73) Assignee: Coretronic Corporation, Hsin-Chu (TW)

(21) Appl. No.: 19/176,089

(22) Filed: Apr. 10, 2025

(30) Foreign Application Priority Data
Apr. 16, 2024 (CN) 202410453593.0

(51) Int. Cl. G03B 21/16; G03B 21/20

(52) U.S. Cl. CPC G03B 21/16; G03B 21/2013

(57) ABSTRACT

A projection device and a control method thereof. When an abnormality occurs in a fan, M light emitting elements among N light emitting elements are turned off, and a driving current of (N−M) light emitting elements is adjusted to be higher than a preset current, and when the driving current of P light emitting elements among the N light emitting elements is lower than the preset current, at least one of the P light emitting elements is turned off, and the driving current of a remaining portion that are not turned off of the P light emitting elements is adjusted to be higher than the preset current, so that when the fan is abnormal and needs to be turned off, or when the fan needs to be turned off in low noise/low brightness mode, a heat dissipation module may still be used to effectively dissipate heat.

### CROSS-REFERENCE TO RELATED APPLICATION

This application claims the priority benefit of China application serial no. 202410453593.0, filed on Apr. 16, 2024. The entirety of the above-mentioned patent application is hereby incorporated by reference herein and made a part of this specification.

### BACKGROUND

### Technical Field

The disclosure relates to a display device, and particularly relates to a projection device and a control method thereof.

### Description of Related Art

In a conventional laser DLP projector, fans are mainly used with heat dissipation fins to dissipate the heat generated by the main heating components inside the projector (such as laser light sources, DMD, phosphor wheels, etc.) to the air outside the projector. Although heat dissipation is possible, there will be noise issues when the fan is operating. Generally speaking, when the projector is in a situation where the temperature is lower, the fan will operate at a normal rotation speed (lower noise), and when the projector is in a situation where the temperature is higher, the fan will operate at a higher rotation speed (higher noise).

To further reduce the heat generated by the heating components inside the projector, in addition to increasing the fan rotation speed, it can also be achieved by decreasing the driving current of the laser light source. However, as shown in FIG. 1, the laser light source is, for example, one or more laser light emitting diodes. At a smaller driving current (such as when the driving current is close to a threshold current that starts the laser diode to start emitting light, for example, in the range of 1 to 1.5 A), each laser diode exhibits a wall plug efficiency (WPE) lower than a wall plug efficiency when the driving current is greater than 1.5 A at an operating temperature such as 55 degrees in FIG. 1, and at higher operating temperatures (85 degrees in FIG. 1), the decrease in the wall plug efficiency is more obvious, which will instead lead to more heat generation, and will also cause issues of poor luminous efficacy and color distortion.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projection device and a control method thereof, which can further effectively reduce the heat generated by the projection device while reducing noise.

Other objectives and advantages of the disclosure may be further known from technical features disclosed in the disclosure.

In order to achieve one of or a part of or all of the foregoing objectives or other objectives, a projection device of the disclosure includes an illumination module, an optical engine module, a projection lens, at least one fan, and a control circuit. The illumination module is configured to provide an illumination beam, and the illumination module includes N light emitting elements, where N is an integer greater than 1. The optical engine module includes a light valve. The light valve is configured to convert the illumination beam into an image beam. The projection lens is configured to project the image beam from the light valve out of the projection device. The fan is configured to dissipate heat from at least one heat source in the projection device. The control circuit is coupled to the fan and the illumination module, and is configured to control a driving current of each N light emitting elements. The control circuit is configured to: when an abnormality occurs in the fan, turn off M light emitting elements among the N light emitting elements, and adjust the driving current of each of the (N−M) light emitting elements to be higher than a preset current, where M is an integer greater than or equal to 1 and less than N; or when the driving current of each of the P light emitting elements among the N light emitting elements is lower than the preset current, turn off at least one of the P light emitting elements, and adjust the driving current of a remaining portion that are not turned off of the P light emitting elements to be higher than the preset current, where P is an integer greater than 1 and less than or equal to N.

The disclosure also provides a control method of a projection device. The projection device includes an illumination module, at least one fan, and a control circuit. The illumination module includes N light emitting elements. The control circuit is coupled to the fan and the illumination module and is configured to control a driving current of each of the N light emitting elements. N is an integer greater than 1. The control method includes the following steps. An illumination beam is provided by the illumination module. It is determined whether an abnormality occurs in the fan. When an abnormality occurs in the fan, M light emitting elements among the N light emitting elements are turned off via the control circuit, and the driving current of each of the (N−M) light emitting elements is adjusted to be higher than a preset current, where M is an integer greater than or equal to 1 and less than N; or it is determined whether the driving current of each of the N light emitting elements is lower than the preset current, when the driving current of each of the P light emitting elements among the N light emitting elements is lower than the preset current, at least one of the P light emitting elements is turned off, and the driving current of a remaining portion that are not turned off of the P light emitting elements is adjusted to be higher than the preset current, where P is an integer greater than 1 and less than or equal to N.

Based on the above, embodiments of the disclosure may turn off M light emitting elements among the N light emitting elements when an abnormality occurs in the fan, and may adjust the driving current of the (N−M) light emitting elements to be higher than the preset current, and when the driving current of the P light emitting elements among the N light emitting elements is lower than the preset current, one of the P light emitting elements is turned off, and the driving current of the remaining portion that are not turned off of the P light emitting elements is adjusted to be higher than the preset current, so that when the fan is abnormal or in low noise/low brightness mode, heat may be effectively dissipated.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic diagram of a wall plug efficiency of a conventional laser light emitting diode and a current of a laser diode.

FIG. 2A is a schematic diagram of a projection device according to an embodiment of the disclosure.

FIG. 2B is a schematic diagram of a projection menu projected by the projection device.

FIG. 2C is a schematic diagram of a menu projected by the projection device.

FIG. 3 is a schematic diagram of a projection device according to another embodiment of the disclosure.

FIG. 4 and FIG. 5 are flowcharts of a control method of a projection device according to an embodiment of the disclosure.

FIG. 6 and FIG. 7 are schematic diagrams of a heat dissipation module according to an embodiment of the disclosure.

FIG. 8 is a flowchart of a control method of a projection device according to an embodiment of the disclosure.

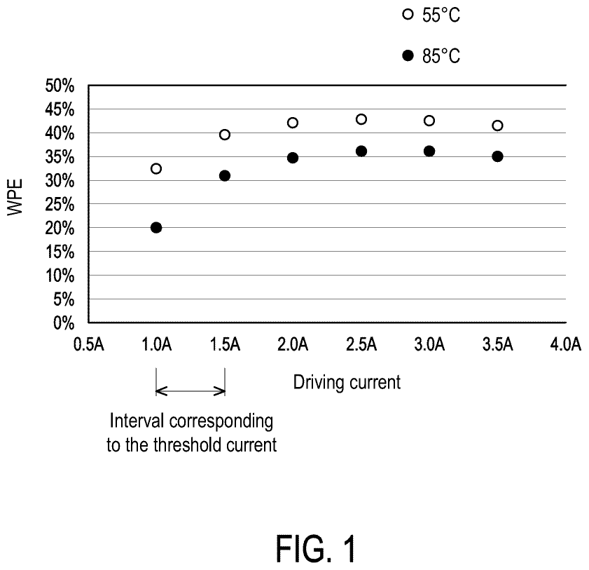

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

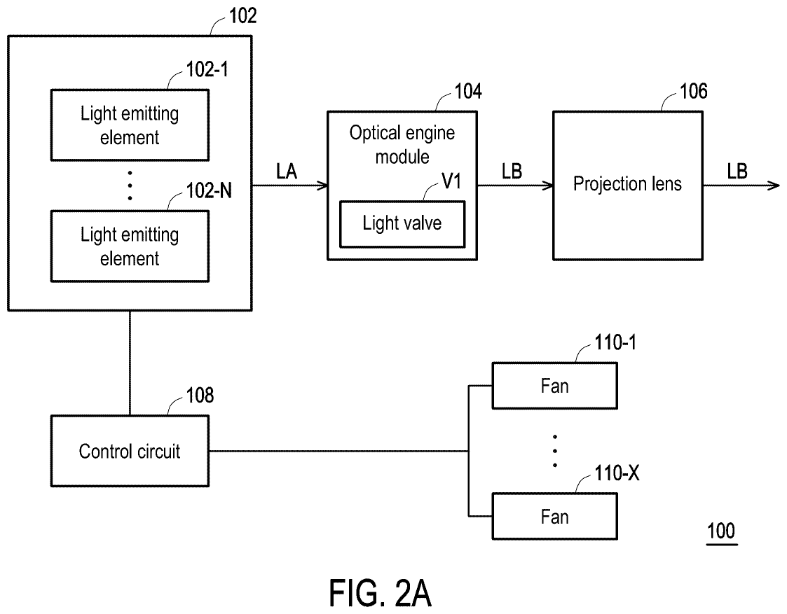

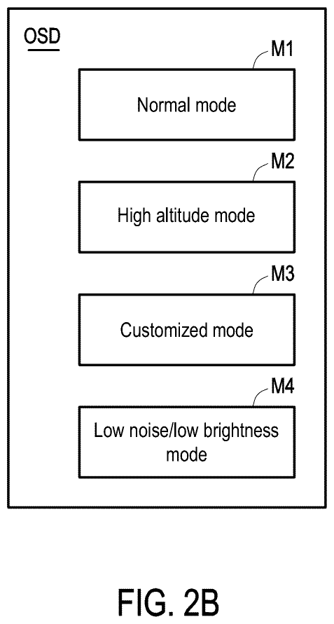

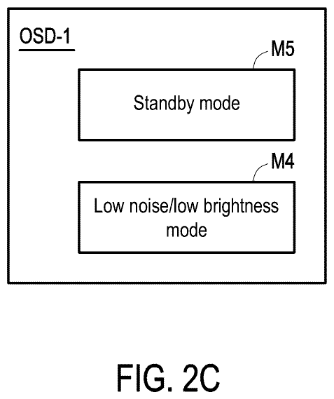

FIG. 2A is a schematic diagram of a projection device according to an embodiment of the disclosure. Please refer to FIG. 2A.

A projection device 100 may include an illumination module 102, an optical engine module 104, a projection lens 106, a control circuit 108, and at least one fan. The control circuit 108 is coupled to the illumination module 102 and the at least one fan. In the embodiment, the at least one fan includes, for example, a plurality of fans 110-1 to 110-X. The control circuit 108 is coupled to the plurality of fans 110-1 to 110-X, where X is an integer greater than 1. In some embodiments, the at least one fan may, for example, include only one fan, but the disclosure is not limited thereto.

The illumination module 102 is configured to provide an illumination beam LA to the optical engine module 104. Furthermore, the illumination module 102 may include N light emitting elements 102-1 to 102-N, where N is an integer greater than 1. The light emitting elements 102-1 to 102-N may respectively provide light beams. The illumination module 102 combines the light beams provided by the light emitting elements 102-1 to 102-N, for example, through a combining system to form the illumination beam LA. It should be noted that, the light combining system is, for example, a combination of light combining prisms, reflectors, light splitting elements, lenses, or other optical elements, such as being composed of wavelength conversion elements, light homogenizing elements, filter elements, and a plurality of light splitting and combining elements to form light of different wavelengths. The light of different wavelengths may be transferred to the optical engine module 104 as illumination beams LA separately or simultaneously. The detailed structure and implementation may be obtained from common knowledge in the field with sufficient teachings, suggestions, and implementation instructions. The light emitting elements 102-1 to 102-N may be, for example, laser diodes (LDs) or/and light emitting diodes (LEDs), but the disclosure is not limited thereto. In the embodiment, each of the light emitting elements 102-1 to 102-N is, for example, a laser diode (LD).

The optical engine module 104 is configured on a transmission path of the illumination beam from the illumination module 102. The optical engine module 104 may include a light valve V1. The light valve V1 is configured to convert the illumination beam LA into an image beam LB. The light valve V1 may be implemented by, for example, a digital micro-mirror device (DMD) or a liquid crystal panel (LCD), but the disclosure is not limited thereto. The projection lens 106 is configured on a transmission path of the image beam LB to project the image beam LB from the light valve V1 out of the projection device 100. The at least one fan dissipates heat from at least one heat source in the projection device 100. For example, the heat source may be the light emitting elements 102-1 to 102-N or/and the light valve V1, but the disclosure is not limited thereto.

The control circuit 108 may control a driving current of each of the N light emitting elements 102-1 to 102-N, so as to control whether the light emitting elements 102-1 to 102-N provide the light beams, and adjust the brightness of the light beam of each of the light emitting elements 102-1 to 102-N, and may control the rotation of the plurality of fans 110-1 to 110-X. The control circuit 108 may turn off M light emitting elements among the N light emitting elements 102-1 to 102-N when there is an abnormality occurring in at least one of the plurality of fans 110-1 to 110-X, and may adjust the driving current of (N−M) light emitting elements other than the M light emitting elements, such that the driving current of each of the (N−M) light emitting elements is higher than a preset current, where M is an integer greater than or equal to 1 and less than N. The preset current may, for example, be greater than a threshold current at which each of the light emitting elements 102-1 to 102-N may start to emit light, and less than a normal operating current of each of the light emitting elements 102-1 to 102-N in an operating state, so as to prevent the light emitting element from increasing the heat generated by the projection device 100 due to low wall plug efficiency.

Continuing from the above, since the normal operating current of the light emitting element in the operating state has better wall plug efficiency, the heat generation may be greatly reduced. Therefore, when an abnormality occurs in the fan, part of the light emitting elements in the illumination module 102 are still turned on. That is to say, the number M of the light emitting elements that are turned-off is greater than or equal to 1, but less than the total number N of the light emitting elements of the illumination module 102. In this way, by turning off part of the light emitting elements and allowing each of the remaining light emitting elements that are not turned off to provide light beams in an operating state with a driving current higher than the preset current, it can effectively prevent the light emitting element from increasing the heat generated by the projection device 100 due to low wall plug efficiency, thereby reducing the temperature of the projection device 100. When an abnormality occurs in the fan, even if the fan is turned off, the projection device 100 may still be ensured to be at an appropriate operating temperature. In the embodiment, when an abnormality occurs in the fan, the driving current of each of the light emitting elements that is not turned off is, for example, adjusted to be slightly higher than the preset current. For example, when an abnormality occurs in the fan, the driving current of the five light emitting elements that are not turned off is adjusted to be slightly higher than the preset current of 1.5 A to ensure that the projection device 100 is at an appropriate operating temperature.

In some embodiments, when an abnormality occurs in at least one of the plurality of fans 110-1 to 110-X, each of the at least one fan may be turned off, that is to say, all the fans are turned off (the plurality of fans 110-1 to 110-X are all turned off), and part of light emitting elements are turned off, so that the driving current of each of the light emitting elements that is not turned off is adjusted to be higher than the preset current, thereby effectively reducing the heat generated by the projection device 100. Even if all the plurality of fans 110-1 to 110-X are turned off, the projection device 100 may still operate normally. In other embodiments, it is also possible to turn off only the abnormal fan and turn off part of the light emitting elements, so that the driving current of each of the light emitting elements that is not turned off is higher than the preset current, without being limited to turning off all the fans.

Furthermore, in the embodiment, as shown in FIG. 2B, the projection device 100 is configured to project a projection menu OSD (on-screen display, such as an on-screen display menu). The projected projection menu OSD comprises a normal mode M1, a high altitude mode M2, a customized mode M3, and a low noise/low brightness mode M4. When the operating mode of the projection device 100 switches to the low noise/low brightness mode, it is determined whether the driving current of each of the N light emitting elements 102-1 to 102-N is lower than the preset current, and it is determined that the driving current of P light emitting elements is lower than the preset current. Further, when the operating mode of the projection device 100 switches to the low noise/low brightness mode M4 and the driving current of each of the P light emitting elements among the N light emitting elements 102-1 to 102-N is lower than the preset current, at least one of the plurality of fans 110-1 to 110-X is turned off. In addition, when the projection device 100 is in the low noise/low brightness mode M4 and the driving current of each of the P light emitting elements among the N light emitting elements 102-1 to 102-N is lower than the preset current, the control circuit 108 may turn off at least one of the P light emitting elements, and adjust the driving current of the remaining light emitting elements that are not turned off of the P light emitting elements to be higher than the preset current, where P is an integer greater than 1 and less than or equal to N. In this way, by turning off part of the light emitting elements and allowing the driving current of the remaining light emitting elements that are not turned off to be higher than the preset current, the projection device 100 in the low brightness mode may prevent the light emitting elements from increasing the heat generated by the projection device 100 due to low wall plug efficiency. For example, compared to operating both light emitting elements at a current of 0.5 A, turning off one light emitting element and operating the other light emitting element at a current of 1 A may generate less heat (because of its better wall plug efficiency), and may maintain similar brightness, or when the projection device 100 is in the low noise mode, even if the rotation speeds of the plurality of fans 110-1 to 110-X are turned off or reduced, it is possible to prevent the light emitting elements from increasing the heat generated by the projection device 100 due to low wall plug efficiency, thereby effectively reducing the heat generated by the projection device 100.

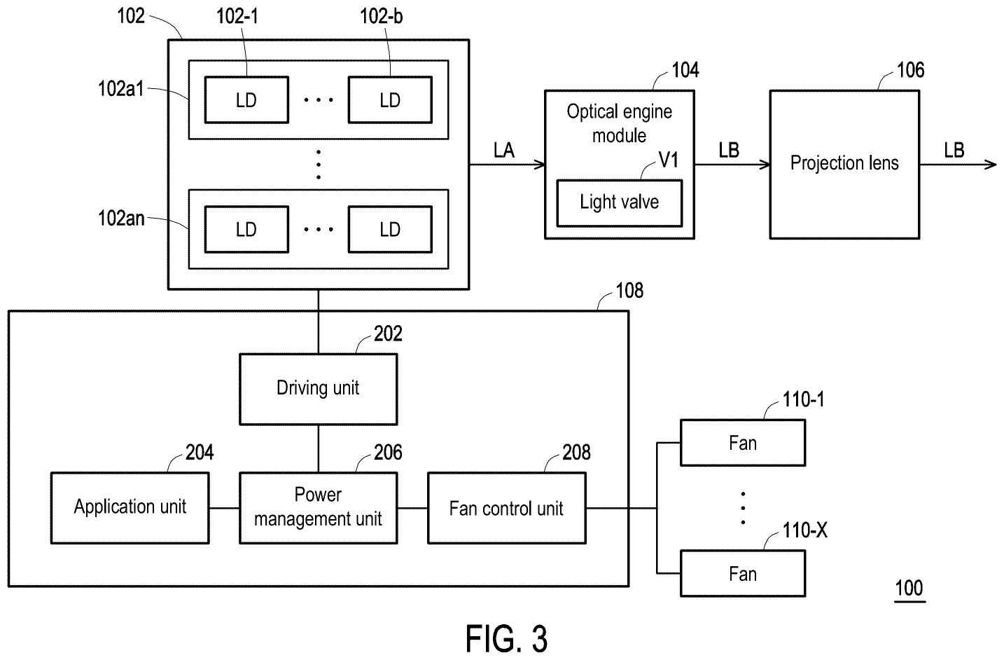

It is worth noting that in other embodiments, the number of P light emitting elements that are turned off is not limited to one in the embodiment. In other embodiments, more light emitting elements may be turned off without significantly affecting the projection quality. In addition, in other embodiments, such as the embodiment of FIG. 3, b light emitting elements (102-1 to 102-b) may also be configured to form a light emitting unit (102a1). If there are n light emitting units, there will be b*n=N optical components, where n is an integer greater than 1 and less than N. Similarly, the control circuit 108 may also reduce the temperature of the projection device 100 by turning off part of the light emitting units and allowing the driving current of the light emitting elements of each of the remaining light emitting units that are not turned off to be higher than the preset current.

Furthermore, the control circuit 108 may include a driving unit 202, an application unit 204, a power management unit 206, and a fan control unit 208 as shown in FIG. 3. The driving unit 202 is coupled to the illumination module 102 and the power management unit 206. The power management unit 206 is also coupled to the application unit 204 and the fan control unit 208. The fan control unit 208 is also coupled to the plurality of fans 110-1 to 110-X. The driving unit 202, the application unit 204, and the fan control unit 208 may be implemented by, for example, a microcontroller chip, and the power management unit 206 may be implemented by, for example, an AC-DC converter, but the disclosure is not limited thereto. The driving unit 202 may be implemented as a light emitting element driver board, for example, and is configured to drive the illumination module 102 to provide the illumination beam LA. The fan control unit 208 is configured to control the operation of the plurality of fans 110-1 to 110-X. The application unit 204 is configured to control the driving unit 202 and the fan control unit 208 through the power management unit 206 according to the abnormality of the fan (such as the fan rotation speed being too slow or stopped) or the operating mode of the projection device 102 (such as the low noise/low brightness mode), so that the illumination module 102 is driven to provide the illumination beam LA and to control the rotation speeds of the plurality of fans 110-1 to 110-X.

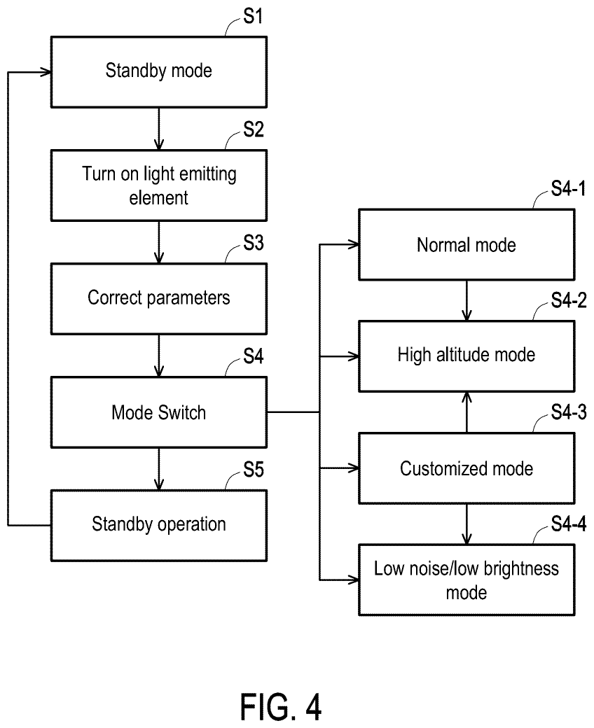

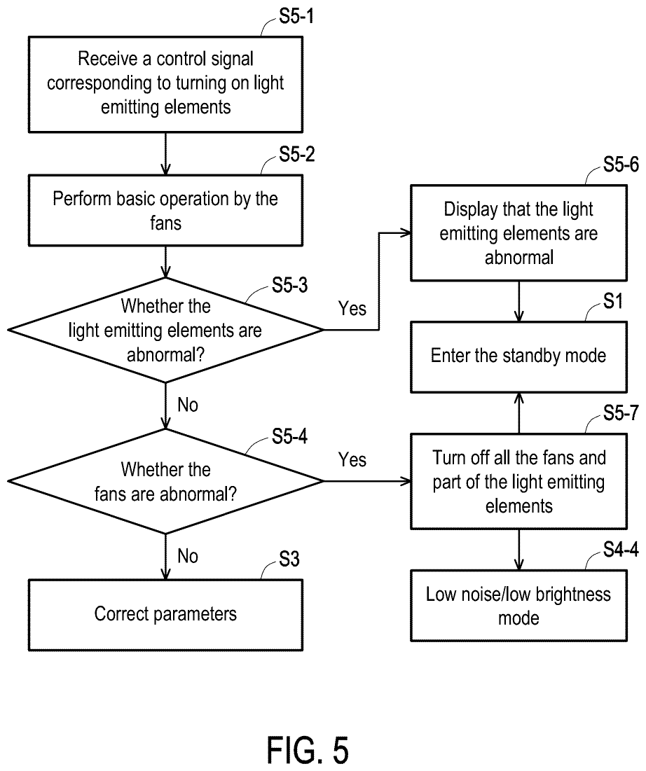

Specifically, the control method of the projection device may be as shown in FIG. 4 and FIG. 5. In FIG. 4, the projection device 100 is initially in a standby mode (step S1). In the embodiment, the standby mode refers to a state in which the projection device 100 is not powered on. When the user presses the power-on button of the projection device 100, the projection device 100 may automatically turn on the light emitting element (step S2), and then correct the control parameters of the plurality of fans 110-1 to 110-X (step S3). For example, the control circuit 108 may adjust the most appropriate rotation speed of the plurality of fans 110-1 to 110-X according to the environment in which the projection device 100 is located (such as altitude, temperature, etc.) and the status of the plurality of fans 110-1 to 110-X (such as aging status). Then, the operating mode of the projection device 100 may be switched according to the correction result of the control parameters. For example, it may be automatically or manually switched to the normal mode (step S4-1), or switched to the high altitude mode (step S4-2), or switched to the customized mode (step S4-3) according to the user's switch control operation, or switched to the low noise/low brightness mode (step S4-4). The normal mode is the general projection mode, which is the initial standard image after the projection device 100 is powered on. In the high altitude mode, the heat dissipation efficiency is poor due to the thin air. Therefore, for example, the plurality of fans 110-1 to 110-X may be controlled to operate at full speed. The switch control operation may be performed, for example, by a remote control or a physical button on the projection device 100 to select the customized mode or the low noise/low brightness mode from the projection menu OSD projected by the projection device 100. In the customized mode, for example, the user may adjust parameters such as brightness or color by himself. In some embodiments, in the customized mode, the projection device 100 may also automatically adjust the brightness of the projected image according to a preset value to improve the user's viewing experience. The low noise/low brightness mode is further described below.

As described in the above embodiment, when the operating mode of the projection device 100 switches to the low noise/low brightness mode, the control circuit 108 may determine whether the driving current of the P light emitting elements among the driving current of each of the N light emitting elements is lower than the preset current, and when it is determined that the driving current of each of the P light emitting elements is lower than the preset current, one of the P light emitting elements is turned off, and the driving current of the remaining light emitting elements that are not turned off among the P light emitting elements is adjusted to be higher than the preset current. In some embodiments, at least one of the plurality of fans 110-1 to 110-X may be further turned off to reduce the noise of the projection device 100.

In some embodiments, the user may perform a standby operation (step S5) on the projection device 100, that is, shut down the projection device 100. For example, all light emitting elements (N light emitting elements 102-1 to 102-N) will be turned off and will return to the standby mode of step S1. In some embodiments, the control circuit 108 may also turn off all the fans when one of the plurality of fans 110-1 to 110-X is abnormal, and automatically switch the operating mode of the projection device 100 to the low noise/low brightness mode or the standby mode. This will be described further below.

Further implementation of step S2 may be as shown in FIG. 5. It should be noted that, further implementation of step S2 corresponds to steps S5-1, S5-2, S5-3, S5-4, S5-6, and S5-7 in FIG. 5, that is to say, when corresponding to step S2 of FIG. 4, the process of FIG. 5 will be further implemented. First, the projection device 100 receives a control signal corresponding to turning on the light emitting element (step S5-1), and causes the control circuit 108 to control the plurality of fans 110-1 to 110-X to perform basic operation at a preset rotation speed (step S5-2), and then it is determined whether the light emitting element is abnormal. For example, whether there is insufficient brightness or flickering, or whether the light emitting element may be turned on (step S5-3). If there is no abnormality occurring in the light emitting element, then it is then determined whether the plurality of fans 110-1 to 110-X (or the fan control unit 208 that controls the plurality of fans 110-1 to 110-X) are abnormal (step S5-4). If there is no abnormality occurring in the plurality of fans 110-1 to 110-X, step S3 in FIG. 4 above is entered for parameter correction. If it is determined in step S5-3 that the light emitting element is abnormal, the control circuit 108 may control the projection device 100 to display the information that the light emitting element is abnormal (step S5-6), and return to step S1 to enter the standby mode. In addition, if it is determined in step S5-4 that the plurality of fans 110-1 to 110-X are abnormal, the control circuit 108 may turn off all the fans and part of the light emitting elements (step S5-7), and control the projection device 100 to enter the low noise/low brightness mode (step S4-4) or the standby mode (step S1). In some embodiments, after turning off all the fans and part of the light emitting elements in step S5-7, the projection device 100 may also project a menu OSD-1 (refer to FIG. 2C) to display the standby mode and the low noise/low brightness mode. And the user may also switch the operating mode of the projection device 100 to the low noise/low brightness mode or the standby mode through the menu.

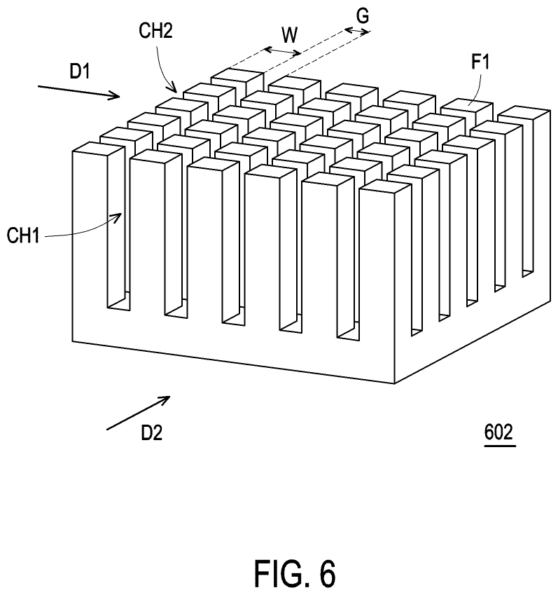

FIG. 6 is a schematic diagram of a heat dissipation module according to an embodiment of the disclosure. In some embodiments, the projection device 100 may further include at least one heat dissipation module 602 as shown in FIG. 6, and the heat dissipation module 602 may be coupled to at least one heat source, for example, a heat source such as a light emitting element or a light valve. The heat dissipation module 602 may include a plurality of fins F1, and the plurality of fins F1 are disposed to be spaced apart from each other. In a first direction D1, there is a first channel CH1 between two adjacent ones of the plurality of fins F1. In a second direction D2, there is a second channel CH2 between two adjacent ones of the plurality of fins F1. Any one of the plurality of fins F1 has a first width W in the first direction D1. The ratio of a width G of the first channel CH1 to the first width W is greater than 0.5. The first width W is greater than or equal to 1 mm. Such a structural design allows the airflow to flow through the first channel CH1 in the first direction D1 and the second channel CH2 in the second direction D2, which can meet the heat dissipation requirements no matter the fan is in operation situation or stop situation, and enhance the heat dissipation performance under natural convection.

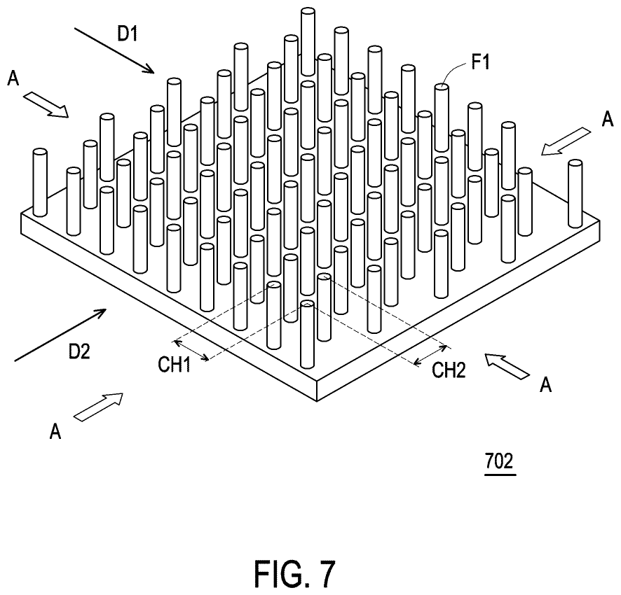

FIG. 7 is a schematic diagram of a heat dissipation module according to another embodiment of the disclosure. In the embodiment, each of the plurality of fins F1 of a heat dissipation module 702 is cylindrical. That is to say, the width of any one of the plurality of fins F1 in the first direction D1 is the same as the width in the second direction D2. As shown in FIG. 7, each of the plurality of fins F1 may be a cylinder, and the diameter thereof may be greater than or equal to 1 mm, but the disclosure is not limited thereto. Similarly, there are the first channel CH1 and the second channel CH2 between two adjacent ones of the plurality of fins F1 in the first direction D1 and the second direction D2 respectively, and the widths of the first channel CH1 and the second channel CH2 are both larger than the width of the fin F1 in the first direction D1 and the second direction D2 (that is, the diameter of the fin F1). Such a structural design allows airflow A to flow through the first channel CH1 in the first direction D1 and the second channel CH2 in the second direction D2, which can meet the heat dissipation requirements no matter the fan is in operation situation or stop situation, and enhance the heat dissipation performance under natural convection.

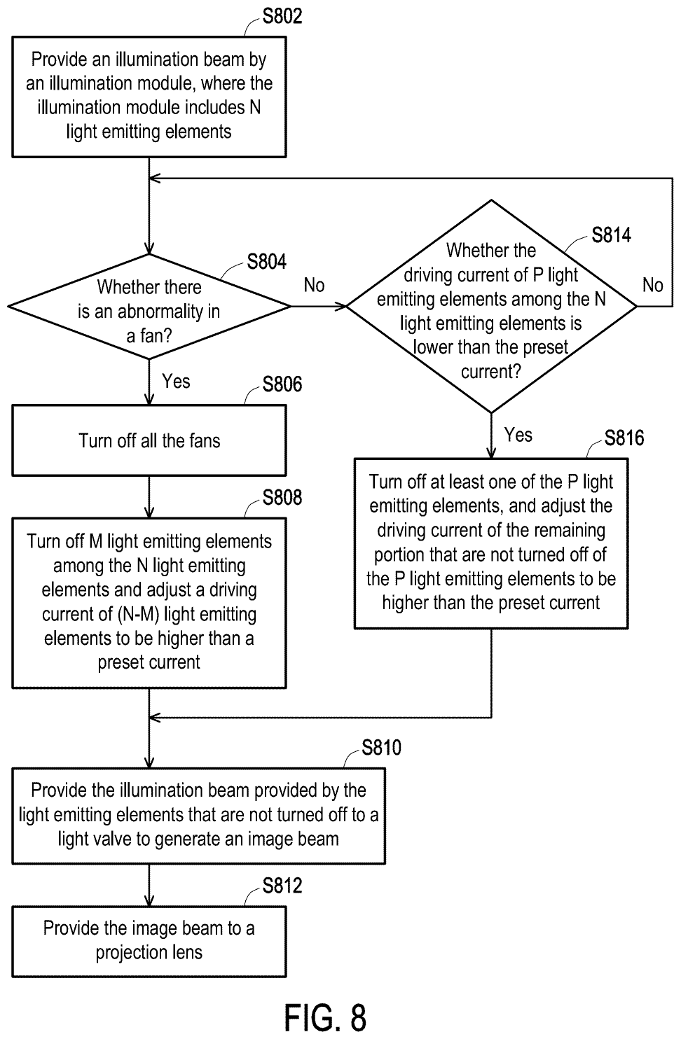

FIG. 8 is a flowchart of a control method of a projection device according to an

embodiment of the disclosure. The projection device includes an illumination module, at least one fan, and a control circuit. The control circuit is coupled to the at least one fan and the illumination module and is configured to control the driving current of each of the N light emitting elements. It can be known from the above embodiments that the control method of the projection device may include at least the following steps. First, an illumination beam is provided by an illumination module. The illumination module includes N light emitting elements (step S802), where N is an integer greater than 1. Next, it is determined whether an abnormality occurs in the at least one fan (step S804). If an abnormality occurs in the at least one fan, all the fans are turned off (step S806), M light emitting elements among the N light emitting elements are turned off through the control circuit, and the driving current of each of the (N−M) light emitting elements is adjusted to be higher than the preset current (step S808), where M is an integer greater than or equal to 1 and less than N. Afterwards, the illumination beam provided by the light emitting elements that are not turned off is provided to the light valve to generate an image beam (step S810), and the image beam is provided to the projection lens (step S812). In addition, in step S804, if it is determined that there is no abnormality occurring in the fan, it can then be determined whether the driving current of each of the N light emitting elements is lower than the preset current (step S814). If the driving current of P light emitting elements among the N light emitting elements is not lower than the preset current (where P is an integer greater than 1 and less than or equal to N), step S804 may be returned so as to continue to determine whether an abnormality occurs in the fan. If the driving current of the P light emitting elements among the N light emitting elements is lower than the preset current, at least one of the P light emitting elements may be turned off, and the driving current of a remaining portion that are not turned off of the P light emitting elements may be adjusted to be higher than the preset current (step S816). Then, step S810 is entered, in which the illumination beam provided by the light emitting elements that are not turned off is provided to the light valve to generate the image beam.

In summary, embodiments of the disclosure may turn off M light emitting elements among the N light emitting elements when an abnormality occurs in the fan, and adjust the driving current of the (N−M) light emitting elements to be higher than the preset current, and when the driving current of the P light emitting elements among the N light emitting elements is lower than the preset current, one of the P light emitting elements is turned off, and the driving current of the other P light emitting elements that are not turned off is adjusted to be higher than the preset current, so that even when the fan is abnormal or in low noise/low brightness mode, heat may be still effectively dissipated.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A projection device, comprising an illumination module, an optical engine module, a projection lens, at least one fan, and a control circuit, characterized in that:
the illumination module is configured to provide an illumination beam, wherein the illumination module comprises N light emitting elements, and N is an integer greater than 1;
the optical engine module comprises a light valve, wherein the light valve is configured to convert the illumination beam into an image beam;
the projection lens is configured to project the image beam from the light valve out of the projection device;
the at least one fan is configured to dissipate heat from at least one heat source in the projection device; and
the control circuit is coupled to the at least one fan and the illumination module and is configured to control a driving current of each of the N light emitting elements, the control circuit being configured to:
when an abnormality occurs in the at least one fan, turn off M light emitting elements among the N light emitting elements, and adjust the driving current of each of the (N−M) light emitting elements to be higher than a preset current, wherein M is an integer greater than or equal to 1 and less than N; or
when the driving current of each of P light emitting elements among the N light emitting elements is lower than the preset current, turn off at least one of the P light emitting elements, and adjust the driving current of a remaining portion of the P light emitting elements to be higher than the preset current, wherein P is an integer greater than 1 and less than or equal to N.

2. The projection device according to claim 1, wherein the projection device is configured to project a projection menu, the projection menu comprises a low noise/low brightness mode of an operating mode of the projection device, and the control circuit is configured to:
when the operating mode of the projection device switches to the low noise/low brightness mode, determine whether the driving current of each of the N light emitting elements is lower than the preset current, and determine that the driving current of the P light emitting elements is lower than the preset current.

3. The projection device according to claim 2, wherein the control circuit is configured to:
when the driving current of each of the P light emitting elements among the N light emitting elements is lower than the preset current, turn off at least one of the at least one fan.

4. The projection device according to claim 1, wherein the control circuit is configured to:
when it is determined that an abnormality occurs in the at least one fan, turn off each of the at least one fan.

5. The projection device according to claim 4, characterized in that: the projection device is configured to project a menu, the menu comprises a standby mode and a low noise/low brightness mode, and after each of the at least one fan and the M light emitting elements are turned off, an operating mode of the projection device is configured to be switched to the low noise/low brightness mode or the standby mode through the menu.

6. The projection device according to claim 1, characterized in that: the control circuit comprises a driving unit, an application unit, a power management unit, and a fan control unit, wherein the power management unit is coupled to the driving unit, the application unit, and the fan control unit, and the application unit is configured to control the driving unit and the fan control unit through the power management unit, so that the driving unit drives the illumination module, and the fan control unit controls an operation of the at least one fan.

7. The projection device according to claim 1, wherein the preset current is greater than a threshold current of each of the N light emitting elements and less than a normal operating current of the N light emitting elements.

8. The projection device according to claim 1, characterized in that the projection device further comprises at least one heat dissipation module, wherein:
the at least one heat dissipation module is coupled to the at least one heat source, each of the at least one heat dissipation module comprises a plurality of fins, and the plurality of fins are disposed to be spaced apart from each other, wherein in a first direction, there is a first channel between two adjacent ones of the plurality of fins, and in a second direction, there is a second channel between two adjacent ones of the plurality of fins.

9. The projection device according to claim 8, characterized in that: any one of the plurality of fins has a first width in the first direction, a ratio of a width of the first channel to the first width is greater than 0.5, and the first width is greater than or equal to 1 mm.

10. The projection device according to claim 8, characterized in that: each of the plurality of fins is cylindrical.

11. The projection device according to claim 10, characterized in that any one of the plurality of fins has a first width in the first direction, and a width of the first channel is greater than the first width.

12. The projection device according to claim 11, characterized in that any one of the plurality of fins has a second width in the second direction, and a width of the second channel is greater than the second width.

13. A control method of a projection device, wherein the projection device comprises an illumination module, at least one fan, and a control circuit, the illumination module comprises N light emitting elements, the control circuit is coupled to the at least one fan and the illumination module and is configured to control a driving current of each of the N light emitting elements, and N is an integer greater than 1, wherein
the control method comprises:
providing an illumination beam through the illumination module;
determining whether there is an abnormality occurring in the at least one fan;
when an abnormality occurs in the at least one fan, turning off M light emitting elements among the N light emitting elements through the control circuit, and adjusting the driving current of each of the (N−M) light emitting elements to be higher than a preset current, wherein M is an integer greater than or equal to 1 and less than N; or
determining whether the driving current of each of the N light emitting elements is lower than the preset current, and when the driving current of each of P light emitting elements among the N light emitting elements is lower than the preset current, turning off at least one of the P light emitting elements, and adjusting the driving current of a remaining portion of the P light emitting elements to be higher than the preset current, wherein P is an integer greater than 1 and less than or equal to N.

14. The control method of the projection device according to claim 13, wherein the projection device is configured to project a projection menu, the projection menu comprises a low noise/low brightness mode of an operating mode of the projection device, and the control method further comprises:
when the operating mode of the projection device switches to the low noise/low brightness mode, determining through the control circuit whether the driving current of each of the N light emitting elements is lower than the preset current, and determining that the driving current of the P light emitting elements is lower than the preset current.

15. The control method of the projection device according to claim 14, further comprising:
when the driving current of each of the P light emitting elements among the N light emitting elements is lower than the preset current, turning off at least one of the at least one fan through the control circuit.

16. The control method of the projection device according to claim 13, further comprising:
when an abnormality occurs in the at least one fan, turning off each of the at least one fan.

17. The control method of the projection device according to claim 16, wherein the projection device is configured to project a menu, the menu comprises a standby mode and a low noise/low brightness mode, and the control method further comprises:
after each of the at least one fan and the M light emitting elements are turned off, switching an operating mode of the projection device to the low noise/low brightness mode or the standby mode through the menu.

18. The control method of the projection device according to claim 13, wherein the control circuit comprises a driving unit, an application unit, a power management unit, and a fan control unit, and the control method further comprises:
controlling the driving unit and the fan control unit by the application unit through the power management unit, so that the driving unit drives the illumination module, and the fan control unit controls an operation of the at least one fan.

19. The control method of the projection device according to claim 13, further comprising:
the preset current being greater than a threshold current of each of the N light emitting elements and less than a normal operating current of the N light emitting elements.
